(19) United States
(12) Patent Application Publication
(10) Pub. No.: US 2014/0005302 A1
(43) Pub. Date: Jan. 2, 2014

(54) GEOPOLYMER AND EPOXY SIMULTANEOUS INTERPENETRATING POLYMER NETWORK COMPOSITION, AND METHODS FOR THE SAME

(71) Applicant: Tnemec Company, Inc., North Kansas City, MO (US)

(72) Inventors: Remi BRIAND, Overland Park, KS (US); Laura J. BETZEN, Lenexa, KS (US); Jeremy M. ETHINGTON, Independence, MO (US); Erin McKENZIE, Shawnee, KS (US); Peter A. SMITH, Parkville, MO (US)

(73) Assignee: Tnemec Company, Inc., North Kansas City, MO (US)

(21) Appl. No.: 14/019,361

(22) Filed: Sep. 5, 2013

Related U.S. Application Data
(63) Continuation-in-part of application No. 12/904,387, filed on Oct. 14, 2010, now Pat. No. 8,536,250.

(51) Int. Cl. C08K 3/34; C04B 28/00; C09J 11/08

(52) U.S. Cl. CPC C08K 3/34; C09J 11/08; C04B 28/006
USPC 523/402; 523/466; 523/447

(57) ABSTRACT

A simultaneous interpenetrating polymer network—geopolymer epoxy composition includes a first component comprised of a waterborne epoxy curing agent and an alkaline silicate solution, and a second component comprised of an epoxy resin and an aluminosilicate. The two components are mixed to produce a SIN-GE composition that cures at ambient temperatures. The SIN-GE composition may be a low-viscosity, sprayable composition, or may be a higher-viscosity composition. The compositions may be used as coatings, adhesives, mortars, casting materials, and the like.

### CROSS-REFERENCE TO RELATED APPLICATIONS

This application is a continuation-in-part of application Ser. No. 12/904,387 filed on Oct. 14, 2010, which is incorporated herein by reference in its entirety.

### BACKGROUND OF THE INVENTION

### 1. Field of the Invention

The present invention relates to simultaneous interpenetrating polymer networks comprising geopolymer and epoxy (hereafter referred to as SIN-GE), wherein, the two components that react to form the SIN-GE comprise a first component that includes a waterborne epoxy curing agent, at least one surfactant and an alkaline silicate solution, and a second component that includes an epoxy resin and an aluminosilicate; coatings utilizing SIN-GE compositions; and methods of making and applying compositions. A SIN is an interpenetrating polymer network obtained by the simultaneous cross-linking of two different polymer systems, without covalent bonds between the two networks [9].

### 2. Introduction

“Geopolymers” have been in use, under that name, since the 1970s, though the use of similar material occurred before that point. The term “geopolymer” refers to a class of aluminum silicate inorganic polymers. Geopolymer binders and cements are typically formed by reacting aluminum and silicon sources that contain AlO₄⁻ and SiO₄ tetrahedral units under highly alkaline conditions at ambient temperatures. Metakaolin is a common aluminosilicate starting material in the formation of geopolymers, useful for manufacturing consistent geopolymers with predictable physical properties. Other aluminosilicate sources, such as Type F fly ash, have also been used.

Geopolymers typically have the following general formula [4]:

Mₙ[-(Si—O₂)_{z}—(Al—O₂)—]ₙ

Where M is a monovalent cation, z defines the ratio of Si to Al, and n is the degree of polymerization. M is typically an alkali metal such as lithium, sodium, potassium, or cesium.

The ratio of Si to Al in a geopolymer defines the properties of a geopolymer and, therefore, also the possible applications of the geopolymer [7]. Geopolymers having a Si:Al ratio of 1:1 are known as poly(sialate) geopolymers. Those geopolymers having a Si:Al ratio of 2:1 are known as poly(sialate-siloxo) geopolymers. Those having a Si:Al ratio of 3:1 are known as poly(sialate-disiloxo) geopolymers. Typically, all of these types of geopolymers form three-dimensional networks that are very rigid. Higher ratios of Si:Al yield two-dimensional or even linear structures

Geopolymers are typically formed by mixing waterglass with a metakaolin (calcined aluminosilicate) to form a paste. The waterglass typically includes highly-caustic compounds such as LiOH, NaOH, KOH, or CsOH in an appropriate amount of water into which amorphous silica is dissolved. Additional amorphous silica is often utilized, which may be in the form of dry particles and/or a liquid form, such as a dispersion. During the formation of the geopolymer, a three-part chemical reaction takes place: 1) dissolving the aluminosilicate and additional amorphous silica into the waterglass, 2) polycondensation or polymerization of AlO₄⁻ and SiO₄ tetrahedra into a random network; and 3) precipitation into circular polysialates.

Geopolymers are suitable for use in a variety of applications, including coatings, refractory adhesives, low-CO₂-producing cements, isochemical ceramics, and more. They are strong, light-weight, and quick setting, and are generally considered more “green” than other materials used in the art due to the lack of volatile organic compounds and the fact that geopolymers only release small amounts of CO₂ compared to Ordinary Portland Cement (OPC). The production of OPC follows the reaction below [2, 3]:

$$5 {CaCO}_{3} + 2 {SiO}_{2} {}^{Δ} ( 3 CaO , {SiO}_{2} ) ( 2 CaO , {SiO}_{2} ) + 5 {CO}_{2}$$

This reaction emits CO₂ in two ways: burning of the fossil fuel to provide the heat necessary for the reaction and as a direct reaction product. Whereas, the only CO₂ emitted in the production of geopolymers solely comes from the burning of fossil fuels to calcine the kaolin into metakaolin. Producing 1 ton of OPC generates 1 ton of CO₂, whereas, 1 ton of geopolymeric cement generates 0.180 tons of CO₂.

Coatings are used for a variety of protective and decorative functions. Coatings may, for example, be used for protection of vehicles, structures, or their component parts, from corrosion, chemical degradation, temperature, pressure, radiation, abrasion, and weathering elements such as ice, wind, and rain.

Organic coatings have been used for the purposes described above. Production of such coatings, however, often requires the use of harmful or hazardous materials. Some of the materials are volatile and enter the atmosphere during the coating production process or afterward, when the coating is in use. These volatile components are essentially pollutants and the adverse impact of these components on the atmosphere and environment renders them undesirable. Further, production of organic coatings often entails the use of large volumes of petroleum products, thus rendering the environmental footprint of these coatings even larger than from the volatile components alone. Organic coatings also tend to degrade or become otherwise damaged by high-heat conditions. Many organic bonds begin to decompose at temperatures around 400° C. or lower. Some organic compounds begin to breakdown or outgas volatile components at an even lower temperature.

Epoxy polymers have been in use since the 1940s. For ambient cure applications, epoxy resins are reacted with a variety of curing agents. Traditional epoxy coatings are solvent borne, and more recently 80-100% solids by volume. In the last two decades, waterborne epoxy systems have been developed, which can reduce the volatile organic compound (VOC) content due to the use of water as an exempt solvent. Epoxy coatings are desirable because of their high hardness, toughness, corrosion resistance, and adhesion. Waterborne epoxies typically have high hardness, toughness, and adhesion, but their corrosion resistance and water resistance is not as good as solventborne or high solids epoxies, and they typically have lower volume solids. Waterborne epoxies also lose adhesion after long-term immersion in 140° F. deionized water. For these reasons, waterborne epoxies have not been successful in penetrating the industrial protective coatings market for severe environments, such as immersion service coatings, tank linings, or coastal marine applications.

Inorganic coatings have a number of advantages over organic coatings. Inorganic coatings tend to be less expensive than organic coatings because they can be made from abundant natural resources. Inorganic coatings are also generally more highly resistant to heat than organic coatings. However, traditional inorganic coatings do suffer from disadvantages as well. For example, traditional cementitious inorganic coatings tend to be brittle and crack easily, do not exhibit the same degree of flexibility generally found in an organic coating, and tend to adhere poorly to organic or polymeric substrates.

Geopolymer coatings, which are inorganic, also suffer from some of the disadvantages described above. For example, geopolymer coatings may suffer from shrinkage and cracking at high water levels, which may result in loss of adhesion or premature corrosion. This limit on the amount of water that can be used with traditional geopolymer coatings also limits the properties of the resulting coating. Literature generally provides the following ideal molar ratios for geopolymer components: 1.00 M₂O; 1.00 Al₂O₃; 4.00 SiO₂; and 11.00 H₂O [5]. When the molar ratio of water is increased from the value given here, geopolymer coatings tend to shrink, crack, or the like.

The combination of a geopolymer and latex in a coating has been found to prevent cracking in a 2008 patent [4]. This patent is for a geopolymer composition involving geopolymer-containing filler particles and film forming geopolymer precursors. Both in situ and premade geopolymers are contained in the composition. Latex could be added as a toughening agent to the composition.

Geopolymers have been described as a possible filler for a curable epoxy resin composition for use as an electrically insulating material [6]. In this instance, the geopolymer portion is not created in situ, but rather used as a premade filler.

It has been previously reported that geopolymer and epoxy hybrid compositions can be created in situ [7]. A separate geopolymer paste was prepared and added to a mixture of liquid epoxy resin and curing agent. This mixture was cured at 60° C. for 6 hours then post cured at 180° C. for 2 hours. It was determined that when geopolymer is incorporated into an epoxy system, the thermal stability is improved. There are five components used to make this composition, and three separate mixing steps. These five separate components must be mixed at the time of use. In the first step, the three components of the geopolymer paste are mixed in one container. In the second step, the liquid epoxy resin and curing agent are mixed in a second container. At this point, the mixtures made in step one and step two are not shelf stable, and therefore cannot be stored over time. In the third step, the previous two mixtures are blended together.

### SUMMARY OF THE INVENTION

The present invention provides a simultaneous interpenetrating polymer network—geopolymer and epoxy (SIN-GE) composition including two components. The first component includes a waterborne epoxy curing agent, at least one surfactant and an alkaline silicate solution. The second component includes an epoxy resin and an aluminosilicate. When the first and second components are mixed, they form a SIN-GE composition that cures at ambient temperatures. In various embodiments of the present invention, the composition may be thinned with water and/or solvent to obtain the proper application viscosity. Likewise, in various embodiments of the present invention, water and/or solvent may be added to either or both components before they are mixed together to obtain the proper application viscosity.

The at least one surfactant listed in the first component of the SIN-GE composition may include at least one anionic surfactant or at least one nonionic surfactant. In addition, the at least one surfactant may be a plurality of surfactants each of which may independently be an anionic surfactant or a nonionic surfactant.

In various embodiments of the present invention, the aluminosilicate source may be metakaolin.

In various embodiments of the present invention, the SIN-GE composition may contain up to about 72% water. Water may be present in various constituents of the two components, added to either of the two components, or added, for example, as a thinner, to the mixed combination of the two components.

In various embodiments of the present invention, the SIN-GE composition may further include a filler, defoamer, pigment, toughening agent, hydrophobic agent, dispersant, thickener, plasticizer, catalyst, solvent, or a combination of these. Any of these may be present in either, both or neither of the first and second components.

In various embodiments of the present invention, the waterborne epoxy curing agent of the first component, may be present in an amount of from about 0.3% to about 45% by weight of the SIN-GE composition.

The present invention, in various embodiments, may include water in the first component. The water may be present in the first component in an amount of from about 5.2% to about 48% by weight of the SIN-GE composition.

In various embodiments of the present invention, the at least one surfactant of the first component, may be present in an amount of from about 0.07% to about 13% by weight of the SIN-GE composition.

In various embodiments of the present invention, the alkaline silicate solution of the first component may be present in an amount of from about 3.3% to about 31% by weight of the SIN-GE composition.

In various embodiments of the present invention, the epoxy resin of the second component may be present in an amount of from about 1.2% to about 80% by weight of the SIN-GE composition.

The present invention, in various embodiments, includes an aluminosilicate source in the second component. The aluminosilicate source may be present in an amount of from about 1.5% to about 27% by weight of the SIN-GE composition.

In various embodiments of the present invention, the geopolymer:epoxy weight ratio of the composition may be from about 10:90 to about 90:10.

In various embodiments of the present invention, the M₂O:Al₂O₃:SiO₂ molar ratio of the composition may be about 0.4 to about 1.5: about 0.5 to about 1.5: about 0.7 to about 40 or, alternatively expressed, as from about 0.4:0.5:0.7 to about 1.5:1.5:40. Similarly, the M₂O:Al₂O₃:SiO₂ molar ratio of the composition of the present invention may be about 0.8 to about 1.2: about 0.8 to about 1.2: about 3 to about 30 or, alternatively expressed, as from about 0.8:0.8:3 to about 1.2:1.2:30.

The present invention also provides a simultaneous interpenetrating polymer network—geopolymer and epoxy (SIN-GE) composition including two components, where the first component may include from about 2% to about 34% by weight of a waterborne epoxy curing agent, from about 13% to about 42% by weight of water, from about 1% to about 8% by weight of at least one surfactant and from about 8% to about 27%, by weight of an alkaline silicate solution. The second component may include from about 7% to about 64% of an epoxy resin and from about 3% to about 17% of an aluminosilicate. When the first and second components are mixed, they form a SIN-GE composition that cures at ambient temperatures.

The present invention also provides a method of applying a SIN-GE composition to a substrate

In various embodiments, the present invention includes applying the SIN-GE to a substrate as a coating, mortar, adhesive, or casting material via spraying, brushing, rolling, troweling, pouring, dipping, casting, or injecting.

The present invention, in various embodiments, further includes the capability of the SIN-GE composition to cure at ambient temperature.

In various embodiments, the present invention provides a composition including from about 0.5% to about 10% by weight of fibers added to produce an adhesive composition. The fibers may be organic or inorganic fibers, such as, for example, polyolefin fibers, carbon fibers, wollastonite, fiberglass, and combinations thereof.

In various embodiments the present invention provides a composition to which from about 100% to 250% by weight of sand is added to produce a mortar composition.

The present invention, in various embodiments, further provides a composition to which sand and fiber are added, totaling from about 100% to about 250% by weight to produce a mortar composition.

In various embodiments the present invention provides a composition to which from about 10-500% pigment or extender is added.

In various embodiments, the present invention also includes methods of making geopolymer-epoxy compositions as described above. The methods comprise of: a) preparing a first component by combining a waterborne epoxy curing agent, at least one surfactant and an alkaline silicate solution; b) preparing a second component by combining an epoxy resin and an aluminosilicate source; and c) combining the first and second components. When mixed together, the first and second components form a simultaneous interpenetrating polymer network—geopolymer and epoxy (SIN-GE) composition that cures at ambient temperature. In various aspects of the embodiment, the methods may further comprise including water in the composition to achieve a desired application viscosity. This is achieved by including the water in either or both of the first and second components. In addition to this or as an alternative, the water may be added to the SIN-GE composition after the first and second components are combined.

### DETAILED DESCRIPTION

The present invention relates to a composition comprising two components that react to form a simultaneous interpenetrating polymer network—geopolymer epoxy (SIN-GE) composition when mixed together. A simultaneous interpenetrating polymer network is formed by polymerizing two different monomer and cross-linking agent pairs in one step [9]. A first component of the present composition includes a waterborne epoxy curing agent, at least one surfactant and an alkaline silicate solution. A second component includes an epoxy resin and an aluminosilicate. When combined, the first and second components produce in situ SIN-GE. Prior to mixing the two components, no geopolymer or cross-linked epoxy is present.

In some embodiments of the present invention, metakaolin may be used as the aluminosilicate source. Metakaolin is a dehydroxylated form of kaolin, and methods of producing metakaolin are known in the art. It is contemplated that any suitable aluminosilicate source may be used in conjunction with the present invention. Exemplary aluminosilicate sources are described below.

The SIN-GE compositions of the present invention offer several advantages over other compositions commonly used in the art. The present compositions can be made with little to no volatile organic solvents and therefore minimize the negative environmental impact associated with the emission of VOCs. When the compositions utilize VOCs, the strictest VOC regulations can still be met. Water is used in some embodiments in the preparation of the present compositions and may be present up to 72% by weight of the composition, depending on the desired properties of the final composition. Water may be present in or incorporated into various constituents of the formulation, such as in the epoxy resin or the epoxy curing agent resin, or added as a separate constituent. Further, the arrangement of the constituents in each of the two components allows for longer shelf-stability than compositions commonly used in the art.

The present SIN-GE compositions may also include other materials in addition to those mentioned above. A variety of extenders may be used in order to influence the physical properties of the final composition. These extenders include zinc compounds, barium compounds, sulfate compounds, strontium compounds, calcium compounds, iron compounds, graphite, silica compounds, silicate compounds, titanium compounds, geopolymer particles, organic polymer fibers, and inorganic fibers. Various inorganic or organic color pigments may also be included as dry pigments or as pre-dispersed pigments.

The present SIN-GE compositions may be applied to a substrate in any suitable manner: the word “substrate” is used broadly herein to refer to any surface onto which the present compositions may be applied. Some embodiments of the present compositions are suitable for application to a substrate by spraying. Other higher viscosity embodiments may be applied to a substrate in other ways. The present compositions may be used as coatings, mortars, adhesives, or as casting materials. Individual materials of the present compositions, including water, can be varied in terms of percent by weight in order to produce a final composition suitable for a desired end-use.

Exemplary SIN-GE Compositions

The precise quantities and relative quantities of each of the materials of the present composition may vary according to the desired physical properties of the final composition. Preferred values, provided as percent by weight, are given below.

TABLE 1
Preferred Material Ranges

| | Wt. % of Material |
|---|---|
| First Component: | |
| Waterborne Epoxy Curing Agent | 0.3-45% |
| Water | 5.2-48% |
| Surfactant | 0.07-13% |
| Sodium Silicate or Potassium Silicate Solution | 3.3-31% |
| Second Component: | |
| Epoxy Resin | 1.2-80% |
| Aluminosilicate | 1.5-27% |
| Geopolymer:Epoxy Weight Ratio | 10-90:10-90 |
| M₂O:Al₂O₃:SiO₂ Molar Ratio | 0.4-1.5:0.5-1.5:0.7-40 |

Table 1, above, provides preferred ranges for the various materials of the present coating composition. For each range disclosed, it is contemplated that each point within the disclosed range is a viable percent weight for the material associated with that range, and that the disclosure of the ranges in Table 1 constitutes disclosure of the individual points falling within the ranges.

Also, in various of the formulations provided herein, metakaolin may be used as an aluminosilicate source. It is further contemplated that any suitable aluminosilicate may be used with respect to any of the various compositions disclosed herein, so long as the aluminosilicate is suitable for the preparation of a geopolymer. Exemplary aluminosilicates include metakaolin, fly ash, coal gangue, zeolite, silica fume, cement, and combinations of these. In various embodiments in which the aluminosilicate is metakaolin, it provides a consistent geopolymer product with predictable physical properties. Further, type F fly ash may be used to produce geopolymers, however, in certain embodiments the fly ash may be less desirable due to impurities, such as calcium and iron, in the fly ash. These impurities can in certain embodiments, add chemical reaction pathways during the geopolymerization process and can result in substantial changes in the final product, including changes to setting times, slump, strength, and shrinkage.

The waterborne epoxy curing agent, as listed in the table above, may include any resin or combination of resins that react with epoxide functionalities in the presence of water. The curing agent may or may not contain water.

The epoxy resin, as listed in the table above, may include any resin or combination of resins that has epoxide functionality. Examples of epoxy resins include solids, liquids, dispersions, novolacs, diluents, and any other suitable type that is known in the art.

Sodium silicate or potassium silicate may constitute the alkaline silicate solutions in Table 1, above. In addition to sodium silicate and potassium silicate, for example, lithium silicate or cesium silicate may be used.

The term surfactant is used generally in Table 1, as well as in Tables 2 and 3 shown below, and can represent a single surfactant or a combination of surfactants. Surfactants are commonly classified as cationic, anionic, or nonionic. It has been found that anionic and nonionic types are more effective in the present invention. Examples of surfactants of the present invention include DISPERBYK®-2151 (BYK USA Inc., 524 South Chemy Street, Wallingford, Conn. 06492); TRITON® X-405 (The Dow Chemical Company, 2030 Dow Center, Midland, Mich. 48674) and DISPARLON® AQ 330 (DISPARLON is a Trademark of Kusumoto Chemical Ltd., Tokyo, Japan; Products distributed by King Industries, Inc. Science Road, Norwalk, Conn. 06852). Further, more than one surfactant may be used advantageously to ensure long-term compatibility of the constituents in the first component.

A defoamer may also be present in either, both or neither of the first and second components. If present, any suitable defoamer or anti-foaming agent known in the art may be used with the present coatings. One example of a defoamer is AGITAN® 701 (Münzing Chemie GmbH, Salzstrasse 174, D-74076 Heilbronn, Germany).

In each of the above instances wherein a suitable material other than that provided in Table 1 is used, it is contemplated that one of skill in the art will be able to readily ascertain the appropriate amount of the material to use based on Table 1, above, and the percents by weight of other materials used.

Table 2, below, provides another exemplary range distribution for use in producing a composition of the present invention. The values provided in Table 2 are an alternate embodiment to those provided in Table 1. As with Table 1, above, the specific materials listed in Table 2 may be replaced with other suitable materials. Further, the ranges set forth in Table 2 are meant to encompass each individual point within each range.

TABLE 2
More Preferred Material Ranges

| | Wt. % of Material |
|---|---|
| First Component: | |
| Waterborne Epoxy Curing Agent | 2-34% |
| Water | 13-42% |
| Surfactant | 1-8% |
| Sodium Silicate or Potassium Silicate Solution | 8-27% |
| Second Component: | |
| Epoxy Resin | 7-64% |
| Aluminosilicate | 3-17% |
| Geopolymer:Epoxy Weight Ratio | 20-60:40-80 |
| M₂O:Al₂O₃:SiO₂ Molar Ratio | 0.8-1.2:0.8-1.2:3-30 |

Table 3, below, provides another alternate embodiment of percentages by weight of the various materials that make up the first and second components of the present coating composition. The materials listed in Table 3 may be replaced with any other suitable material.

TABLE 3
Most Preferred Material Percents by Weight

| | Wt. % of Material |
|---|---|
| First Component: | |
| Waterborne Epoxy Curing Agent | 7.1% |
| Water | 17.9% |
| Surfactant | 2.3% |
| Sodium Silicate or Potassium Silicate Solution | 11.6% |
| Second Component: | |
| Epoxy Resin | 54.9% |
| Aluminosilicate | 6.2% |
| Geopolymer:Epoxy Weight Ratio | 25:75 |
| M₂O:Al₂O₃:SiO₂ Molar Ratio | 1:1:3.77 |

Method of Making the Present Composition

In general, the first and second components of the present composition are made separately by mixing the materials in the order presented in the tables. The second component is then added to the first component and stirred. Similarly, in some embodiments of the present invention, the first component may be added to the second component and stirred. Water may be added to achieve proper viscosity, depending on the desired application. The resulting composition may be applied via spray, brush, roll, dip, casting, or other suitable methods. Any method to apply inorganic or organic compositions may also be used. During the cure of the composition, both the epoxy and the geopolymer are polymerized in situ. It is recommended that fillers and/or pigments be added at approximately 10%-500% to the above embodiments and may be included in one or both of the two components and/or added as a third component.

The present composition may be provided in a variety of viscosity ranges, depending on the specific formulation used, and the end use for the composition. A clear formulation, thinned for conventional suction spray, preferably has a viscosity of 20 to 30 seconds as measured in a Zahn EZ cup. Using the same method of viscosity measurement, a zinc-rich formulation thinned for conventional suction spray preferably has a viscosity in the same 20 to 30 second range. A white formulation may have a viscosity of about 60 Krebs units (KU) to about 130 KU, depending on the intended method of application. A mortar formulation of the present invention preferably has a viscosity similar to any Portland cement-based mortar, and allows for easy trowelability. An adhesive formulation of the present composition preferably has a viscosity of about 60 KU to about 140 KU.

In addition to viscosity, the present compositions have a dry film thickness (DFT) that may vary depending on the specific formulation used and the intended end use of the composition. For example, a clear composition preferably has a DFT of about 2 to 80 mils. A zinc rich composition preferably has a DFT of about 1.5 to 10 mils. A white composition preferably has a DFT of about 2 to 80 mils, similar to the clear composition, while a mortar composition preferably has a thickness of ¼ inch or more. An adhesive composition preferably has a thickness of about 2 to 50 mils. An insulation composition or intumescent composition each preferably has a thickness of about 2 to 250 mils.

Additional Compositions

As noted above, compositions of the present invention may be used for adhesive and mortar applications. Compositions used for such applications may differ from those exemplary compositions discussed above in terms of their composition.

An adhesive composition of the present invention may include fibers from about 0.5% to about 10% by weight. Fibers used in such compositions of the present invention may include organic fibers, inorganic fibers, or combinations of the two. Exemplary fibers include polyolefin fibers, cellulose fibers, carbon fiber, wollastonite, fiberglass, and the like. Any fibers suitable for use in an adhesive composition may be used in the adhesive compositions of the present invention, and it is contemplated that such fibers will be readily ascertainable by one of ordinary skill in the art upon reading this disclosure. An exemplary adhesive composition can be prepared, for example, by utilizing the component percentages for the composition given in Table 3, above, and adding about 10% by weight of fibers.

A mortar composition of the present invention preferably includes additional sand, fibers, or combinations thereof, added from about 100% to about 250% by weight. For example, a mortar composition of the present invention may include 100% to 250% by weight of sand, 100% to 250% by weight of fiber, or a combination of sand and fiber totaling 100% to 250% by weight. The fibers suitable for use in a mortar composition may be inorganic or organic fibers, such as those discussed with respect to adhesive compositions above. An exemplary mortar composition can be prepared, for example, by utilizing the material percentages for the composition given in Table 3, above, and adding about 250% by weight of sand, fiber, or a combination of sand and fiber.

Additional Materials

In addition to the materials described above, for example in Tables 1, 2, and 3, the compositions of the present invention may include additional materials depending on the intended use of a given composition. These additional materials are generally present in small amounts and will not substantially affect the percentages by weight of the other materials. In the event that the percentages by weight of the other materials have to be modified due to the inclusion of an additional material, it is contemplated that such modification is within the ability of one of ordinary skill in the art who has read this disclosure.

For example, a clear composition of the present invention may form white spots when used for certain applications (e.g. spraying the composition onto panels). These spots may become a focal point for corrosion and the like. It has been determined, however, that the inclusion of a dispersant in the formulation prevents the occurrence of the white spots. The dispersant is preferably a copolymer dispersant with pigment affinic groups. The dispersant, if present, is preferably included in the second component, though it can alternatively or additionally be included in the first component.

The compositions of the present invention may include one or more fillers as necessary or desirable according to the intended use of the composition. The specific types and forms of fillers and the amounts used, ranging from about 10% to about 500%, will also depend on the intended use of the coating. Exemplary fillers include: inorganic fillers such as quartz, talc, mica, wollastonite, diatomaceous earth, zeolites, kaolin, sepiolite, bentonite, dolomite, various aluminosilicates, barium sulfate, strontium sulfate, calcium carbonate, zinc dust, zinc flake, zinc oxide, zinc phosphate, modified zinc phosphate, modified zinc oxide, iron oxide, crystalline silica, fumed silica, iron phosphide, garamite, montmorillonite, ceramic, glass, elemental iron, nepheline syenite, calcium silicate, graphite, aluminum flake, feldspar, cristobalite, carbon fibers, granite, silica aerogel, geopolymer, basaltic fibers, inorganic fibers; and organic fillers such as cellulosic materials, polymeric hollow beads, polymeric fibers (polypropylene, Kevlar, for example) and the like.

Pigments, dyes, and colorants may also be included such as: zinc oxide, iron oxide, chromium oxide, bismuth vanadate, phthalocyanine blue, phthalocyanine green, organic pigments, carbon black, lamp black, mixed metal oxides inorganic pigments or pre-dispersed forms of these.

Toughening agents may be used to alter the physical properties of the present compositions [4]. For example, ethylene/vinyl laurate/vinyl chloride terpolymers may be used as toughening agents. By adding an increasing amount of toughening agent to the present compositions, one can cause the compositions to have physical properties more similar to an organic coating, whereas reducing the amount of toughening agent utilized can cause the resultant coating to have physical properties more similar to an inorganic coating.

Hydrophobic agents can be used to impart more hydrophobic properties to the compositions of the present invention. As an example, a polyethylene wax or a powder form of silane provided on a carrier matrix is suitable for use as a hydrophobic agent with the present compositions.

Dispersants may also be used to aid in the dispersal of the materials of the present compositions. The type of dispersant used depends on the various materials used in any composition. The amount of dispersant used will depend on the specific type of dispersant utilized, as well as the various other materials of any given composition. One example of a dispersant is DISPERBYK®-194 (BYK USA Inc., 524 South Chemy Street, Wallingford, Conn. 06492). The dispersant, if present, may be included in the second component.

Thickeners can be used to adjust the viscosity of the present compositions. The type and amount of thickener used depends on the various materials in the composition. Examples of suitable thickeners are associative thickeners, non-associative thickeners, inorganic thickeners, mixed mineral thixotropes, organic thixotropes, and any other suitable thickener known in the art.

Plasticizers may also be used in conjunction with the present compositions. Examples of suitable plasticizers are benzyl alcohol and polymerized melamine sulfonate.

Catalysts may also be used to alter the curing rate of the present compositions. Examples of suitable catalysts for the epoxy/curing agent reaction include: tertiary amines such as ANCAMINE® K54, ANCAMINE® 1110, ANCAMINE® K61B or AMICURE® DBU-E (Air Products and Chemicals, Inc., 7201 Hamilton Blvd., Allentown, Pa. 18195-1501); acrylates such as trimethylolpropane triacrylate (TMPTA) or hexanediol diacrylate (HDODA); and acids such as salicylic acid or para-toluenesulfonic acid (PTSA). Examples of suitable catalysts for the geopolymer reaction include: organotin catalysts such as dibutyl tin dilaurate (DBTDL) or COTIN® 280 (Vertellus Specialties, Inc., 300 North Meridian Street Suite 1500, Indianapolis, Ind., 46204); tetrabutylammonium fluoride (TBAF); calcium containing compounds; or any Lewis acid or Lewis base. Any other suitable catalyst for epoxy-curing agent reactions and/or geopolymer reactions may also be used.

Solvents may also be used. The type and amount of solvent used depends on the various materials used in any composition and may be chosen by one of ordinary skill in the art.

### ASPECTS OF THE INVENTION

The present invention includes the following aspects.

### Aspect 1

A geopolymer-epoxy composition comprising: a) a first component comprising a waterborne epoxy curing agent, at least one surfactant and an alkaline silicate solution; and b) a second component comprising an epoxy resin and an aluminosilicate source, wherein, when mixed together, said first and second components form a simultaneous interpenetrating polymer network—geopolymer and epoxy (SIN-GE) composition that cures at ambient temperature.

### Aspect 2

The composition according to aspect 1, further comprising water, wherein said water is included in the composition to achieve a desired application viscosity.

### Aspect 3

The composition according to aspect 2, wherein said water comprises up to 72% by weight of said composition.

### Aspect 4

The composition according to aspect 1, wherein the at least one surfactant comprises at least one anionic surfactant or at least one nonionic surfactant.

### Aspect 5

The composition according to aspect 1, wherein the at least one surfactant is a plurality of surfactants.

### Aspect 6

The composition according to aspect 5, wherein each of the plurality of surfactants is independently selected from the group consisting of an anionic surfactant and a nonionic surfactant.

### Aspect 7

The composition according to aspect 1, wherein the first component alkaline silicate solution is sodium silicate solution or potassium silicate solution.

### Aspect 8

The composition according to aspect 1, wherein the second component aluminosilicate source is metakaolin.

### Aspect 9

The composition according to aspect 1, wherein the SIN-GE composition further comprises a material selected from the group consisting of fillers, defoamers, pigments, toughening agents, hydrophobic agents, dispersants, thickeners, plasticizers, catalysts, solvents, and combinations thereof.

### Aspect 10

The composition according to aspect 1, wherein the first component waterborne epoxy curing agent is present in the SIN-GE composition at a percent by weight from about 0.3% to about 45%.

### Aspect 11

The composition according to aspect 10, wherein the first component waterborne epoxy curing agent is present in the SIN-GE composition at a percent by weight from about 2% to about 34%.

### Aspect 12

The composition according to aspect 2, wherein the first component water is present in the SIN-GE composition at a percent by weight from about 5.2% to about 48%.

### Aspect 13

The composition according to aspect 12, wherein the first component water is present in the SIN-GE composition at a percent by weight from about 13% to about 42%.

### Aspect 14

The composition according to aspect 1, wherein the first component at least one surfactant is present in the SIN-GE composition at a percent by weight of from about 0.07% to about 13%.

### Aspect 15

The composition according to aspect 14, wherein the first component at least one surfactant is present in the SIN-GE composition at a percent by weight of from about 1% to about 8%.

### Aspect 16

The composition according to aspect 1, wherein the first component alkaline silicate solution is present in the SIN-GE composition at a percent by weight of from about 3.3% to about 31%.

### Aspect 17

The composition according to aspect 16, wherein the first component alkaline silicate solution is present in the SIN-GE composition at a percent by weight of from about 8% to about 27%.

### Aspect 18

The composition according to aspect 1, wherein the second component epoxy resin is present in the SIN-GE composition at a percent by weight from about 1.2% to about 80%.

### Aspect 19

The composition according to aspect 18, wherein the second component epoxy resin is present in the SIN-GE composition at a percent by weight from about 7% to about 64%.

### Aspect 20

The composition according to aspect 1, wherein the second component aluminosilicate source is present in the SIN-GE composition at a percent by weight from about 1.5% to about 27%.

### Aspect 21

The composition according to aspect 20, wherein the second component aluminosilicate source is present in the SIN-GE composition at a percent by weight from about 3% to about 17%.

### Aspect 22

The composition according to aspect 1, wherein the composition has a geopolymer:epoxy weight ratio from about 10:90 to about 90:10.

### Aspect 23

The composition according to aspect 1, wherein the composition has a M₂O:Al₂O₃:SiO₂ molar ratio from about 0.4:0.5:0.7 to about 1.5:1.5:40.

### Aspect 24

The composition according to aspect 1, further comprising fibers selected from the group consisting of polyolefin fibers, cellulose fibers, carbon fibers, wollastonite, fiberglass, and combinations thereof.

### Aspect 25

The composition according to aspect 1, further comprising fibers, wherein said fibers are added to the composition from about 0.5% to about 10% by weight to produce an adhesive composition.

### Aspect 26

The composition according to aspect 1, further comprising sand, wherein said sand is added to the composition from about 100% to about 250% by weight to produce a mortar composition.

### Aspect 27

The composition according to aspect 1, further comprising fibers, wherein said fibers are added to the composition from about 100% to about 250% by weight to produce a mortar composition.

### Aspect 28

The composition according to aspect 26, further comprising fibers, wherein the combination of sand and fibers is added at a total weight percent from about 100% to about 250% to produce a mortar composition.

### Aspect 29

A method of making a geopolymer-epoxy composition, the method comprising: a) preparing a first component by combining a waterborne epoxy curing agent, at least one surfactant and an alkaline silicate solution; b) preparing a second component by combining an epoxy resin and an aluminosilicate source; and c) mixing together the first and second components, wherein, when mixed together, said first and second components form a simultaneous interpenetrating polymer network—geopolymer and epoxy (SIN-GE) composition that cures at ambient temperature.

### Aspect 30

The method according to aspect 29, wherein the method further comprises adding water to either or both of the first and second components and/or adding water to the SIN-GE composition after the first and second components have been combined and wherein water is included in the composition to achieve a desired application viscosity.

### Aspect 31

The method according to aspect 30, wherein water is present at a percent by weight up to about 72% of the SIN-GE composition.

### Aspect 32

The method according to aspect 30, wherein the first component is prepared by combining in order, a waterborne epoxy curing agent, water, at least one surfactant and an alkaline silicate solution.

### Aspect 33

The method according to aspect 29, wherein combining the first and second components comprises adding the second component to the first component.

### Aspect 34

The method according to aspect 29, wherein combining the first and second components comprises adding the first component to the second component.

### Aspect 35

The method according to aspect 29, wherein the at least one surfactant comprises at least one anionic surfactant or at least one nonionic surfactant.

### Aspect 36

The method according to aspect 29, wherein the at least one surfactant comprises a plurality of surfactants.

### Aspect 37

The method according to aspect 36, wherein each of the plurality of surfactants is independently selected from the group consisting of an anionic surfactant and a nonionic surfactant.

### Aspect 38

The method according to aspect 29, wherein the first component alkaline silicate solution is sodium silicate solution or potassium silicate solution.

### Aspect 39

The method according to aspect 29, wherein the second component aluminosilicate source is metakaolin.

### Aspect 40

The method according to aspect 29, wherein the method further comprises adding to the SIN-GE composition a material selected from the group consisting of fillers, defoamers, pigments, toughening agents, hydrophobic agents, dispersants, thickeners, plasticizers, catalysts, solvents, and combinations thereof.

### Aspect 41

The method according to aspect 29, wherein the first component waterborne epoxy curing agent is present in the SIN-GE composition at a percent by weight from about 0.3% to about 45%.

### Aspect 42

The method according to aspect 41, wherein the first component waterborne epoxy curing agent is present in the SIN-GE composition at a percent by weight from about 2% to about 34%.

### Aspect 43

The method according to aspect 30, wherein the first component water is present in the SIN-GE composition at a percent by weight from about 5.2% to about 48%.

### Aspect 44

The method according to aspect 43, wherein the first component water is present in the SIN-GE composition at a percent by weight from about 13% to about 42%.

### Aspect 45

The method according to aspect 29, wherein the first component at least one surfactant is present in the SIN-GE composition at a percent by weight of from about 0.07% to about 13%.

### Aspect 46

The method according to aspect 45, wherein the first component at least one surfactant is present in the SIN-GE composition at a percent by weight of from about 1% to about 8%.

### Aspect 47

The method according to aspect 29, wherein the first component alkaline silicate solution is present in the SIN-GE composition at a percent by weight of from about 3.3% to about 31%

### Aspect 48

The method according to aspect 47, wherein the first component alkaline silicate solution is present in the SIN-GE composition at a percent by weight of from about 8% to about 27%

### Aspect 49

The method according to aspect 29, wherein the second component epoxy resin is present in the SIN-GE composition at a percent by weight from about 1.2% to about 80%.

### Aspect 50

The method according to aspect 49, wherein the second component epoxy resin is present in the SIN-GE composition at a percent by weight from about 7% to about 64%.

### Aspect 51

The method according to aspect 29, wherein the second component aluminosilicate source is present in the SIN-GE composition at a percent by weight from about 1.5% to about 27%.

### Aspect 52

The method according to aspect 51, wherein the second component aluminosilicate source is present in the SIN-GE composition at a percent by weight from about 3% to about 17%.

### Aspect 53

The method according to aspect 29, wherein the composition has a geopolymer:epoxy weight ratio from about 10:90 to about 90:10.

### Aspect 54

The method according to aspect 29, wherein the composition has a M₂O:Al₂O₃:SiO₂ molar ratio from about 0.4:0.5:0.7 to about 1.5:1.5:40.

### Aspect 55

The method according to aspect 29, further comprising adding fibers selected from the group consisting of polyolefin fibers, cellulose fibers, carbon fibers, wollastonite, fiberglass, and combinations thereof.

### Aspect 56

The method according to aspect 29, further comprising adding fibers to the SIN-GE composition in an amount of from about 0.5% to about 10% by weight to produce an adhesive composition.

### Aspect 57

The method according to aspect 29, further comprising adding sand to the SIN-GE composition in an amount of from about 100% to about 250% by weight to produce a mortar composition.

### Aspect 58

The method according to aspect 29, further comprising adding fibers to the SIN-GE composition in an amount of from about 100% to about 250% by weight to produce a mortar composition.

### Aspect 59

The method according to aspect 57, further comprising adding fibers to the SIN-GE composition in an amount of from about 100% to about 250% to produce a mortar composition.

### Aspect 60

A geopolymer-epoxy composition comprising: a) a first component comprising about 7.1% by weight of a waterborne epoxy curing agent, about 17.9% by weight of water, about 2.3% by weight of at least one surfactant and about 11.6% by weight of an alkaline silicate solution; and b) a second component comprising about 54.9% by weight of an epoxy resin, and about 6.2% by weight of an aluminosilicate, wherein, when mixed together, said first and second components form a SIN-GE composition that cures at ambient temperature.

### Aspect 61

The composition according to aspect 60, wherein the composition has a geopolymer:epoxy weight ratio of about 25:75.

### Aspect 62

The composition according to aspect 60, wherein the composition has a M2O:Al2O3:SiO₂ molar ratio of about 1:1:3.77.

In addition to the above, other modifications to the present compositions, substitution of components, and the like, will be readily apparent to one of ordinary skill in the art upon reading this disclosure. Such modifications, substitutions, and the like are contemplated to be within the spirit and scope of the present invention.

### REFERENCES

[1] Briand, Rémi et al., “Geopolymer and Epoxy Simultaneous Interpenetrating Polymer Network Composition and Method for the Same” U.S. 2012/0094028 A1 (Filed Oct. 14, 2010, Published Apr. 19, 2012)
[2] Davidovits, J. “Geopolymers: Inorganic Polymeric New Materials.” J. Therm. Anal., 37, 1633-56 (1991).
[3] Davidovits, J. “Environmentally Driven Geopolymer Cement Applications.” Geopolymer 2002 Conference (Oct. 28-29, 2002).
[4] Xuhong, T.; Jinghua, Y. World Intellectual Property Organization. International Patent Application. WO 2008/113609 A2.
[5] Bell, J.; Kriven, W. “Preparation of Ceramic Foams from Metakaolin-Based Geopolymer Gels.” Developments in Strategic Materials: Ceramic Engineering and Science Proceedings, 29, Issue 10, 97-111 (2008).
[6] Schaal, S., et al. US Patent 2010/0018750 A1.
[7] Hussain, M., et al. “Synthesis and Thermal Behavior of Inorganic-Organic Hybrid Geopolymer Composites.” J. of Applied Polymer Science, 96, 112-121 (2005).
[8] Sagoe-Crentsil, K. “Properties and Performance of Si-Rich Geopolymer Binder Systems.” Mechanical Properties and Performance of Engineering Ceramics and Composites IV: Ceramic Engineering and Science Proceedings, 30, Issue 2 (2009).
[9] Odian, G. Principles of Polymerization: Third Edition, 150 (1991).

All references cited herein are hereby incorporated by reference to the extent relevant and not inconsistent with the present specification. The discussion of the references herein is intended merely to summarize the assertions made by their authors and no admission is made that any reference constitutes prior art. Applicants reserve the right to challenge the accuracy and pertinence of the cited references.

Having thus described the preferred embodiments of the invention, what is claimed as new and desired to be protected by Letters Patent includes what is set forth below.

What is claimed is:

1. A geopolymer-epoxy composition comprising:
a) a first component comprising a waterborne epoxy curing agent, at least one surfactant and an alkaline silicate solution; and
b) a second component comprising an epoxy resin and an aluminosilicate source,
wherein, when mixed together, said first and second components form a simultaneous interpenetrating polymer network—geopolymer and epoxy (SIN-GE) composition that cures at ambient temperature.

2. The composition according to claim 1, wherein the at least one surfactant comprises at least one anionic surfactant or at least one nonionic surfactant.

3. The composition according to claim 1, wherein the first component alkaline silicate solution is sodium silicate solution or potassium silicate solution.

4. The composition according to claim 1, wherein the second component aluminosilicate source is metakaolin.

5. The composition according to claim 1, wherein the SIN-GE composition further comprises a material selected from the group consisting of fillers, defoamers, pigments, toughening agents, hydrophobic agents, dispersants, thickeners, plasticizers, catalysts, solvents, and combinations thereof.

6. The composition according to claim 1, wherein the first component waterborne epoxy curing agent is present in the SIN-GE composition at a percent by weight from about 0.3% to about 45%; the first component water is present in the SIN-GE composition at a percent by weight from about 5.2% to about 48%; the first component surfactant is present in the SIN-GE composition at a percent by weight of from about 0.07% to about 13%; the first component alkaline silicate solution is present in the SIN-GE composition at a percent by weight of from about 3.3% to about 31%; the second component epoxy resin is present in the SIN-GE composition at a percent by weight from about 1.2% to about 80%; and the second component aluminosilicate source is present in the SIN-GE composition at a percent by weight from about 1.5% to about 27%.

7. The composition according to claim 1, wherein the composition has a geopolymer:epoxy weight ratio from about 10:90 to about 90:10 and the composition has a M₂O:Al₂O₃:SiO₂ molar ratio from about 0.4:0.5:0.7 to about 1.5:1.5:40.

8. The composition according to claim 1, further comprising fibers selected from the group consisting of polyolefin fibers, cellulose fibers, carbon fibers, wollastonite, fiberglass, and combinations thereof.

9. The composition according to claim 1, further comprising fibers, wherein said fibers are added to the composition from about 0.5% to about 10% by weight to produce an adhesive composition.

10. The composition according to claim 1, further comprising sand and/or fibers, wherein the combination of sand and fibers is added at a total weight percent from about 100% to about 250% to produce a mortar composition.

11. A method of making a geopolymer-epoxy composition, the method comprising:
a) preparing a first component by combining a waterborne epoxy curing agent, at least one surfactant and an alkaline silicate solution;
b) preparing a second component by combining an epoxy resin and an aluminosilicate source; and
c) mixing together the first and second components,
wherein, when mixed together, said first and second components form a simultaneous interpenetrating polymer network—geopolymer and epoxy (SIN-GE) composition that cures at ambient temperature.

12. The method according to claim 11, wherein the method further comprises adding to the SIN-GE composition and/or adding to either the first component or second component a material selected from the group consisting of fillers, defoamers, pigments, toughening agents, hydrophobic agents, dispersants, thickeners, plasticizers, catalysts, solvents, and combinations thereof.

13. The method according to claim 11, wherein the first component waterborne epoxy curing agent is present in the SIN-GE composition at a percent by weight from about 0.3% to about 45%; the first component water is present in the SIN-GE composition at a percent by weight from about 5.2% to about 48%; the first component surfactant is present in the SIN-GE composition at a percent by weight of from about 0.07% to about 13%; the first component alkaline silicate solution is present in the SIN-GE composition at a percent by weight of from about 3.3% to about 31%; the second component epoxy resin is present in the SIN-GE composition at a percent by weight from about 1.2% to about 80%; and the second component aluminosilicate source is present in the SIN-GE composition at a percent by weight from about 1.5% to about 27%.

14. The method according to claim 11, wherein the composition has a geopolymer:epoxy weight ratio from about 10:90 to about 90:10 and the composition has a M₂O:Al₂O₃:SiO₂ molar ratio from about 0.4:0.5:0.7 to about 1.5:1.5:40.

15. The method according to claim 11, further comprising adding to the composition fibers selected from the group consisting of polyolefin fibers, cellulose fibers, carbon fibers, wollastonite, fiberglass, and combinations thereof.

16. The method according to claim 11, further comprising adding fibers to the composition from about 0.5% to about 10% by weight to produce an adhesive composition.

17. The method according to claim 11, further comprising adding sand and/or fibers to the SIN-GE composition wherein the combination of sand and/or fibers is added at a total weight percent from about 100% to about 250% to produce a mortar composition.

18. A geopolymer-epoxy composition comprising:
a) a first component comprising about 7.1% by weight of a waterborne epoxy curing agent, about 17.9% by weight of water, about 2.3% by weight of surfactant and about 11.6% by weight of an alkaline silicate solution; and
b) a second component comprising about 54.9% by weight of an epoxy resin and about 6.2% by weight of an aluminosilicate,
wherein, when mixed together, said first and second components form a SIN-GE composition that cures at ambient temperature.

19. The composition according to claim 18, wherein the composition has a geopolymer:epoxy weight ratio of about 25:75.

20. The composition according to claim 18, wherein the composition has a M₂O:Al₂O₃:SiO₂ molar ratio of about 1:1:3.77.
